(19) United States
(12) Patent Application Publication
(10) Pub. No.: US 2019/0128842 A1
(43) Pub. Date: May 2, 2019

(54) DIELECTROPHORESIS BASED MECHANICAL ELECTRICAL CELL SENSOR AND METHODS FOR FABRICATING AND USING SAME

(71) Applicants: Mahdi Moghimi Zand, Tehran (IR); Seyed Imman Isaac Hosseini, Tehran (IR); Amir Ali Ebadi, Tehran (IR)

(72) Inventors: Mahdi Moghimi Zand, Tehran (IR); Seyed Imman Isaac Hosseini, Tehran (IR); Amir Ali Ebadi, Tehran (IR)

(21) Appl. No.: 15/802,224

(22) Filed: Nov. 2, 2017

(51) Int. Cl. G01N 27/447; B03C 5/02; B01L 3/00

(52) U.S. Cl. CPC G01N 27/44791; B03C 5/02; G01N 27/44747; B01L 3/502715; B01L 2300/12; B01L 2300/0636; B01L 2300/0645; B01L 2300/16; B01L 2200/10

(57) ABSTRACT

A dielectrophoresis based biosensor for evaluating mechanical and electrical properties of a biological cell is disclosed. Said dielectrophoresis based biosensor comprises a substrate having a surface. The biosensor further comprises a source electrode, a ground electrode and a sensor electrode is positioned on the surface of said substrate, where a dielectrophoretic force is exerted by said electrodes. The source electrode and the ground electrode are separated by a predetermined distance, and the sensor electrode is positioned between the source electrode and the ground electrode. The dielectrophoresis based biosensor further includes a microfluidic channel positioned on the substrate to place the biological cell at a desired position to evaluate the mechanical and electrical properties of a biological cell. The present invention also discloses a method of fabricating dielectrophoresis based biosensor according to an embodiment, and a method of performing test by using dielectrophoresis based biosensor.

### BACKGROUND OF THE INVENTION

Cell mechanics play a critical role in healthy cell and tissue function. Cell mechanics is similarly important in numerous pathologies. Irregular shear stress leads to atherosclerotic plaque formation in arterial bifurcations, osteoarthritic chondrocytes exhibit altered mechanical responses, and decreased red blood cell deformability leads to vascular complications in sickle cell anemia.

Both externally applied and internally generated forces impact cell structure and function, with mechanical factors contributing to signal transduction pathways, gene expression, and stem cell differentiation. While physical forces are increasingly recognized as important in biological systems, henceforth it is required to analyze these forces impact on biological processes at size scales ranging from gene to protein to cell to tissue. Development of new technologies enables the study of single cell mechanics is continually broadening the understanding of the effect of forces on cellular function.

Currently, a wide variety of methods exists to test biological cell mechanics. The cells could be exposed to global loading, in which whole cell properties are measured through techniques such as micropipette aspiration, optical tweezers, and the optical stretcher. Alternatively, the local cell loading could be used to measure the mechanical properties of specific cellular regions through techniques such as magnetic bead micro-rheometry, magnetic twisting cytometry, and atomic force microscopy.

Recently, dielectrophoresis (DEP) based methods have been used for manipulating cells or particles. When the object is placed in an electric field, charges on the body of the object appear in a dipolar distribution across its body. In a uniform electric field, this dipolar charges cause nil net force to the object. However, in a spatially non-uniform electric field, the forces exerted on each dipole end are unequal, causing a certain net force on the object. Such net force may be used to manipulate objects such as cells or particles. If the object is less polarizable than the medium, the overall effective net force draws the object towards the field minimum.

A number of approaches have been proposed to examine the mechanical properties of cells, each of which has weaknesses/drawbacks. In previous studies which used dielectrophoresis method, the deformation of biological cell has been evaluated by image processing. Especially, all of these methods require hefty microscopes for image analysis.

Thus, there is a clear and present need for new ways to detect the response of biological cells to dielectrophoresis without using hefty microscopes. Further, there is a need for new and easier ways to evaluate the mechanical and electrical properties of the bio-particles simultaneously.

### SUMMARY OF THE INVENTION

The present invention relates to a biosensor, and more particularly relates to a dielectrophoresis based biosensor for evaluating mechanical and electrical properties of a biological cell. Said dielectrophoresis based biosensor comprises a substrate having a surface. The biosensor further comprises a source electrode, a ground electrode and a sensor electrode is positioned on the surface of said substrate, a dielectrophoretic force is exerted by said electrodes. In one embodiment, the source electrode and the ground electrode are separated by a predetermined distance, and the sensor electrode is positioned between the source electrode and the ground electrode. In another embodiment, the dielectrophoresis based biosensor further includes a microfluidic channel positioned on the substrate to place the biological cell at a desired position to evaluate the mechanical and electrical properties of a biological cell. The desired position of placing the biological cell is between the source electrode and ground electrode.

In one embodiment, the biosensor further comprises a function generator configured to apply differential potential between the source electrode and the ground electrode to create an electric field in the sensor electrode. In another embodiment, the biosensor further comprising an impedance meter to measure electrical resistance variation between the ground and the sensor electrodes.

In one embodiment, the sensor electrode is configured to analyze the deformation of the biological cell. In some embodiments, the sensor electrode has high permittivity and acts as an electric field barrier. In one embodiment, the electrodes comprise one or more pads to connect the function generator and the impedance meter.

In an embodiment, a method of fabricating dielectrophoresis based biosensor, comprising the steps of providing a substrate with a surface, coating a layer of titanium (Ti) or chromium (Cr) on the surface of the substrate, coating a layer of gold (Au) on the surface of the coated titanium (Ti) or chromium (Cr) layer of the substrate, patterning the coated surface of the substrate to form three electrodes, coating a passivation layer on the surface of said electrodes, and positioning a microfluidic channel to receive a dielectrophoresis buffer with biological cells on the substrate.

In one embodiment, the substrate is one of silicon wafer or glass. The thickness of the substrate is about 1 cm. In one embodiment, the layer of titanium (Ti) or chromium (Cr) is coated on the substrate to intensify the bonding strength between the substrate and gold (Au). In some embodiments, the thickness of the titanium (Ti) or chromium (Cr) layer, and gold layer is about 160 nms. In one embodiment, the passivation layer is coated on the surface of said electrodes using a diluted SU-8.

In one embodiment, the passivation layer is configured to prevent direct contact of the dielectrophoresis buffer with the electrodes. The thickness of the passivation layer is about 1 micron. In one embodiment, the microfluidic channel is polydimethylsiloxane (PDMS)-based microfluidic channel. In some embodiments, the microfluidic channel is positioned on the substrate using plasma bonding method. In one embodiment, the step of patterning the coated surface of the substrate to form three electrodes is done by photolithographic process. In some embodiments, the electrodes include a source electrode, a ground electrode and a sensor electrode.

In one embodiment, the step of coating a layer of titanium (Ti) or chromium (Cr) on the surface of the substrate is done by one of physical vapor deposition method. The physical vapor deposition method is a thermal evaporation in vacuum condition. In one embodiment, the method further comprises the step of coating a layer of gold (Au) on the surface of the coated titanium (Ti) or chromium (Cr) layer of the substrate is done by one of physical vapor deposition method. Herein, the physical vapor deposition method is DC sputtering method.

In an embodiment, a method of performing test by using dielectrophoresis based biosensor is disclosed. The method comprises the step of, isolating or culturing of biological cells, washing and centrifuging the isolated cells, preparing a predetermined concentration of buffer solution and resuspension of cell in the buffer solution, injecting the resuspended cell solution in the microfluidic channel of the biosensor, and applying differential potential and evaluating variation in electrical resistance from a plurality of electrodes in the biosensor to analyze and obtain electrical and mechanical properties of the biological cell. In some embodiments, the predetermined concentration of buffer solution comprises 5% sucrose and 0.8% dextrose. In various embodiments, the differential potential is applied by using a function generator, and the variation in the electrical resistance is evaluated by using an impedance meter.

One aspect of the present disclosure is directed to a dielectrophoresis based biosensor, comprising: (a) a substrate having a surface; (b) a source electrode, a ground electrode and a sensor electrode being positionable on the surface of said substrate where a dielectrophoretic force is exerted by said electrodes, wherein the source electrode and the ground electrode are separated by a predetermined distance, and the sensor electrode is positioned between the source electrode and the ground electrode, and (c) a microfluidic channel positioned on the substrate to place the biological cell at a desired position to evaluate the mechanical and electrical properties of a biological cell. In one embodiment, the dielectrophoresis based biosensor further comprises a function generator configured to apply differential potential between the source electrode and the ground electrode to create an electric field in the sensor electrode. In another embodiment, the dielectrophoresis based biosensor further comprises an impedance meter to measure electrical resistance variation between the ground and the sensor electrodes.

In one embodiment, the desired position of placing the biological cell is between the source electrode and ground electrode. In one embodiment, the sensor electrode has high permittivity and acts as an electric field barrier. In another embodiment, the electrodes comprise one or more pads to connect the function generator and the impedance meter.

Another aspect of the present disclosure is directed to a method of fabricating a dielectrophoresis based biosensor, comprising (a) providing a substrate with a surface; (b) coating a layer of titanium (Ti) or chromium (Cr) on the surface of the substrate; (c) coating a layer of gold (Au) on the surface of the coated titanium (Ti) or chromium (Cr) layer of the substrate; (d) patterning the coated surface of the substrate to form three electrodes; (e) coating a passivation layer on the surface of said electrodes, and (f) positioning a microfluidic channel to receive a dielectrophoresis buffer with biological cells on the substrate. In one embodiment, the substrate is silicon wafer or glass. In one embodiment, the layer of titanium (Ti) or chromium (Cr) is coated on the substrate to intensify the bonding strength between the substrate and gold (Au) layer. In a related embodiment, the thickness of the titanium (Ti) or chromium (Cr) layer, and gold layer is about 160 nms.

In one embodiment, the passivation layer is coated on the surface of said electrodes using a diluted SU-8. In one embodiment, the passivation layer is configured to prevent direct contact of the dielectrophoresis buffer with the electrodes. In another embodiment, the thickness of the passivation layer is about 1 micron. In one embodiment, the microfluidic channel is a polydimethylsiloxane (PDMS)-based microfluidic channel. In another embodiment, the microfluidic channel is positioned on the substrate using plasma bonding method. In one embodiment, the step of patterning the coated surface of the substrate to form three electrodes is done by photolithographic process. In one embodiment, the electrodes include a source electrode, a ground electrode and a sensor electrode.

Another aspect of the present disclosure is directed to a method of performing a test using a dielectrophoresis based biosensor, comprising the steps of: (a) isolating or culturing of biological cells; (b) washing and centrifuging the isolated cells; (c) preparing a predetermined concentration of buffer solution and resuspension of cell in the buffer solution; (d) injecting the resuspended cell solution in the microfluidic channel of the biosensor, and (e) applying differential potential and evaluating variation in electrical resistance from a plurality of electrodes in the biosensor to analyze and obtain electrical and mechanical properties of the biological cell. In one embodiment, the predetermined concentration of buffer solution comprises 5% sucrose and 0.8% dextrose. In another embodiment, the differential potential is applied by using a function generator, and the variation in the electrical resistance is evaluated by using an impedance meter.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

FIG. 1 illustrates a schematic of dielectrophoresis based biosensor according to an embodiment;

FIG. 2A illustrates a dielectrophoresis based biosensor package, according to an embodiment;

FIG. 2B illustrates different layers of electrodes and passivation layer in the dielectrophoresis based biosensor;

FIG. 3 illustrates a method of fabricating dielectrophoresis based biosensor according to an embodiment;

FIG. 4 illustrates a method of performing test by using dielectrophoresis based biosensor;

FIG. 5A is a perspective view of the fabricated dielectrophoresis based biosensor held by an user's hand;

FIG. 5B is a microscopic image of layer of dielectrophoresis based biosensor;

FIG. 6A illustrates a viability of cells stained with Trypan Blue after applying 8V, where most of the cells are viable;

FIG. 6B illustrates a viability of cells stained with Trypan Blue after applying 12V, where most of the cells are dead;

FIG. 7A shows time history of elongation of cells when potential difference is 8V, noticeable deviations are not seen over time;

FIG. 7B shows time history of elongation of cells when potential difference is 12V, noticeable deviations are not seen overtime;

FIG. 7C shows time history of elongation of cells when potential difference is 16V, dielectrophoresis has significantly changed the mechanical response of the cells;

FIG. 8 shows time history of electrical resistance between the sensor and the ground electrodes of gap 18 μm, with the samples 1:0, 1:1 and 0:1 of MDA-MB-231 and MCF-7;

FIG. 9A-FIG. 9D illustrate four microscopic image of a sample combination of MCF-7 and MDA-MB-231 in dielectrophoresis based biosensor, while the gap between sensor and ground electrodes is 18 μm in time 0 s, 60 s, 90 s and 110 s respectively;

FIG. 10 shows time history of electrical resistance between the sensor and ground electrodes, while the gap between them is 20 μm, the samples are 1:0, 1:1 and 0:1 and combination of MDA-MB-231 and MCF-7;

FIG. 11A shows time history of electrical resistance between the sensor and ground electrodes while the gap between them is 18 μm, and the samples are 1:0, 1:1 and 0:1, combination of Treatment-MCF-7 and MCF-7;

FIG. 11B shows time history of electrical resistance between the sensor and ground electrodes while the gap between them is 18 μm, and the samples are 2:1, 1:1 and 1:2 combination of Treatment-MCF-7 and MCF-7;

FIG. 11C shows time history of electrical resistance between the sensor and ground electrodes while the gap between them is 20 μm, and the samples are 1:0, 1:1 and 0:1 combination Of Treatment-MCF-7 and MCF-7; and

FIG. 11D shows time history of electrical resistance between the sensor and ground electrodes while the gap between: them is 20 μm, and the samples are 2:1, 1:1 and 1:2 combination of Treatment MCF-7 and MCF-7.

### DETAILED DESCRIPTION

A description of embodiments of the present invention will now be given with reference to the figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

The present invention generally relates to a biosensor, and more particularly relates to a dielectrophoresis based biosensor for evaluating mechanical and electrical properties of a biological cell.

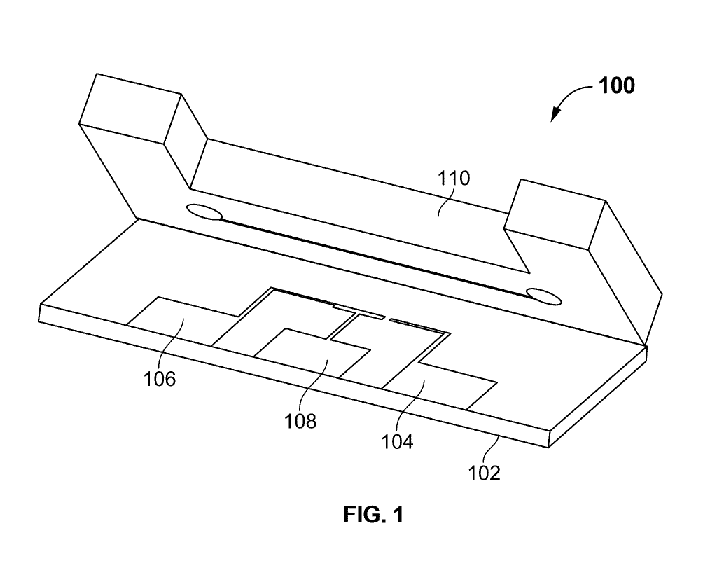

According to an embodiment of the invention, a schematic of dielectrophoresis based biosensor 100, is shown in FIG. 1. The dielectrophoresis based biosensor 100 is configured to evaluate mechanical and electrical properties of a biological cell. Said dielectrophoresis based biosensor 100 comprises a substrate 102 having a surface. The biosensor 100 further comprises a source electrode 104, a ground electrode 106 and a sensor electrode 108 is positioned on the surface of said substrate 102, where a dielectrophoretic force is exerted by said electrodes. In one embodiment, the source electrode 104 and the ground electrode 106 are separated by a predetermined distance, and the sensor electrode 108 is positioned between the source electrode 104 and the ground electrode 106. In another embodiment, the dielectrophoresis based biosensor 100 further includes a microfluidic channel 110 with an inlet 112 and outlet 114, positioned on the substrate 102 to place the biological cell at a desired position to evaluate the mechanical and electrical properties of a biological cell. In one embodiment, the desired position of placing the biological cell is between the source electrode 104 and ground electrode 106.

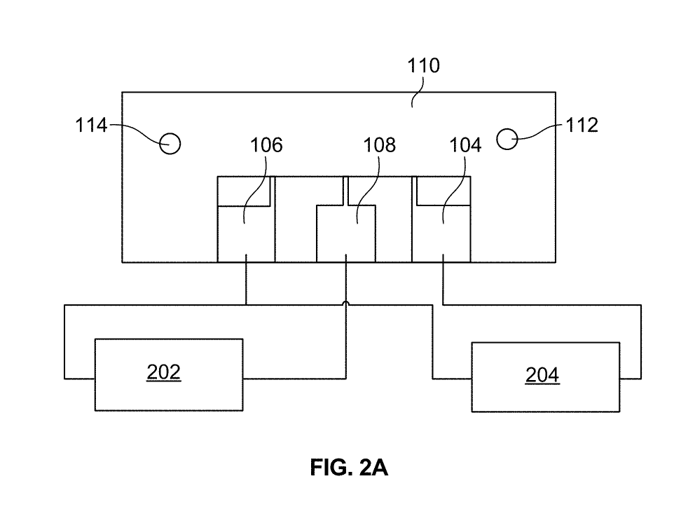

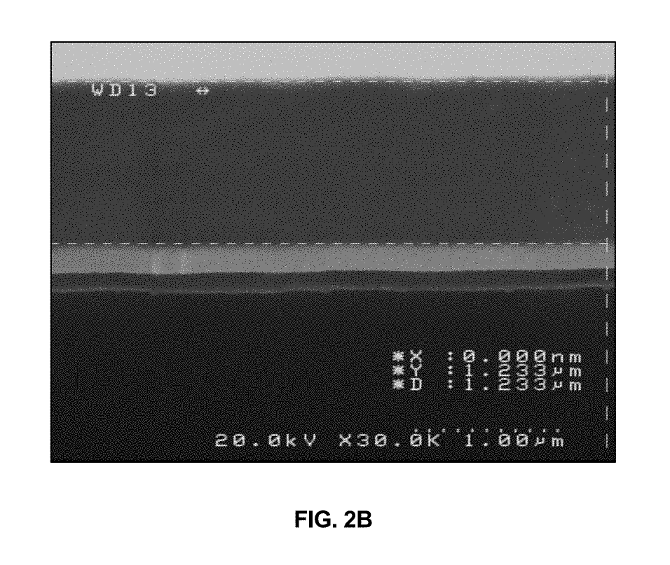

FIG. 2A and FIG. 2B illustrates a dielectrophoresis based biosensor package, and different layers of electrodes and passivation layer in the dielectrophoresis based biosensor, according to an embodiment. In one embodiment, the biosensor 100 further comprises a function generator 202 configured to apply differential potential between the source electrode 104 and the ground electrode 106 to create an electric field in the sensor electrode 108. In another embodiment, the biosensor 100 further comprising an impedance meter 204 to measure electrical resistance variation between the ground electrode 106 and the sensor electrode 108. In one embodiment, the sensor electrode 108 is configured to analyze the deformation of the biological cell. In some embodiments, the sensor electrode 108 has high permittivity and acts as an electric field barrier. In one embodiment, the electrodes comprise one or more pads to connect the function generator 202 and the impedance meter 204.

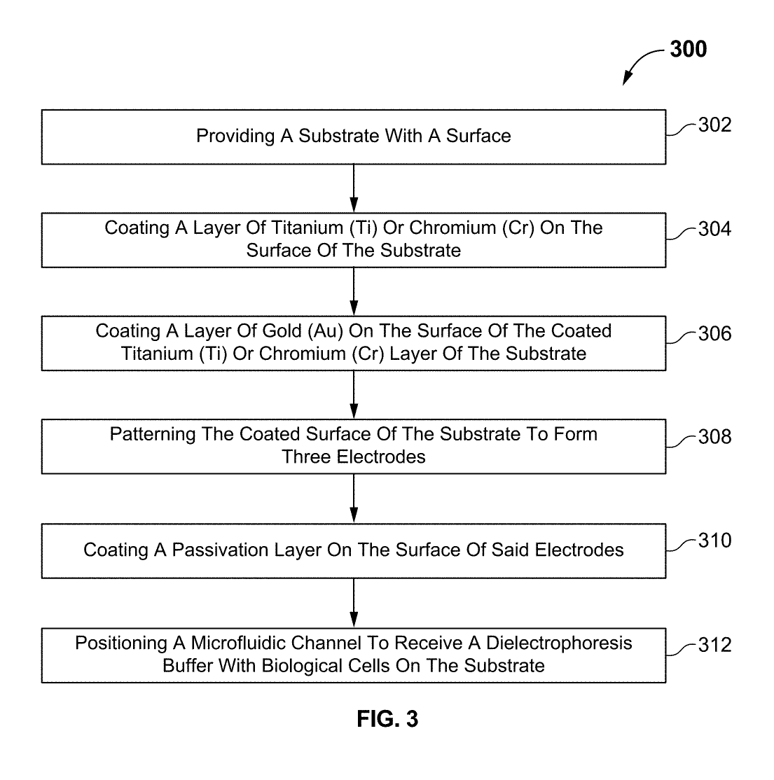

In an embodiment, a method 300 of fabricating dielectrophoresis based biosensor (shown in FIG. 1), is illustrated in FIG. 3. In one embodiment, the method 300 comprises, providing a substrate 102 with a surface in step 302. In one embodiment, the method 300 further comprises coating a layer of titanium (Ti) or chromium (Cr) on the surface of the substrate 102 in step 304. In step 306, the method 300 comprises coating a layer of gold (Au) on the surface of the coated titanium (Ti) or chromium (Cr) layer of the substrate 102.

In step 308, the method 300 further comprises patterning the coated surface of the substrate 102 to form three electrodes, a source electrode 104, a ground electrode 106 and a sensor electrode 108. In one embodiment, the method 300 further comprises coating a passivation layer on the surface of said electrodes in step 310. Finally, in step 312, the method 300 further comprises positioning a microfluidic channel 110 to receive a dielectrophoresis buffer with biological cells on the substrate 102.

Further, referring to FIG. 2B, different layers of electrodes and passivation layer in the dielectrophoresis based biosensor are illustrated. In one embodiment, the substrate 102 is one of silicon wafer or glass. The thickness of the substrate 102 is about 1 cm. In one embodiment, the layer of titanium (Ti) or chromium (Cr) is coated on the substrate 102 to intensify the bonding strength between the substrate 102 and gold (Au) layer. In some embodiments, the thickness of the titanium (Ti) or chromium (Cr) layer, and gold layer is about 160 nms. In one embodiment, the passivation layer is coated on the surface of said electrodes using a diluted SU-8.

In one embodiment of the present invention, the passivation layer is configured to prevent direct contact of the dielectrophoresis buffer with the electrodes. The thickness of the passivation layer is about 1 micron. In one embodiment, the microfluidic channel 110 is polydimethylsiloxane (PDMS)-based microfluidic channel. In some embodiments, the microfluidic channel 110 is positioned on the substrate using plasma bonding method. In one embodiment, the step of patterning the coated surface of the substrate 102 to form three electrodes is done by photolithographic process.

In one embodiment, the step of coating a layer of titanium (Ti) or chromium (Cr) on the surface of the substrate 102 is done by one of physical vapor deposition method. The physical vapor deposition method is a thermal evaporation in vacuum condition. In one embodiment, the method further comprises the step of coating a layer of gold (Au) on the surface of the coated titanium (Ti) or chromium (Cr) layer of the substrate 102 is done by one of physical vapor deposition method. Herein, the physical vapor deposition method is DC sputtering method.

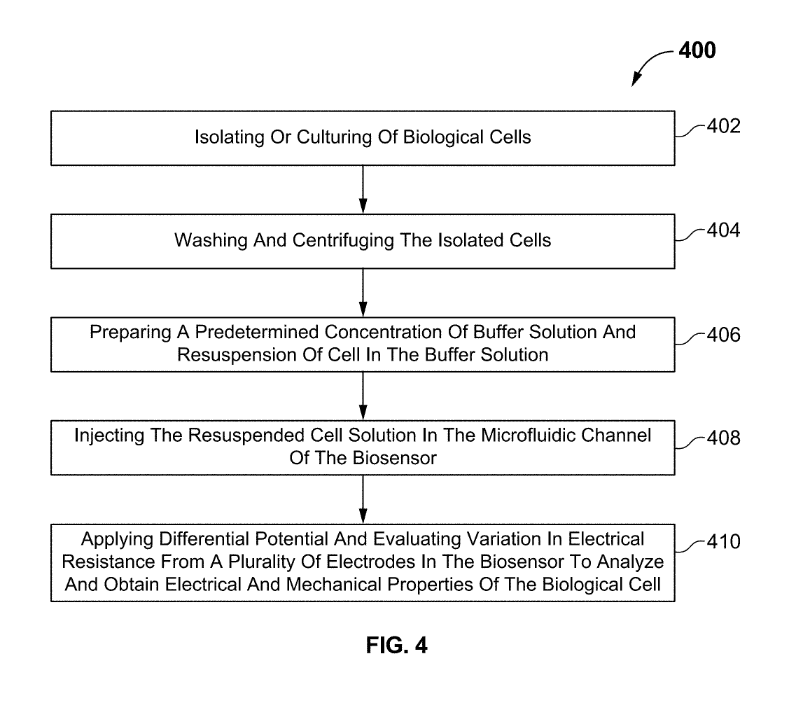

In an embodiment, a method 400 of performing test by using dielectrophoresis based biosensor (shown in FIG. 1), is illustrated in FIG. 4. In step 402, the method 400 comprises the step of, isolating or culturing of biological cells. In step 404, the method 400 comprises washing and centrifuging the isolated cells. The method 400 further comprises, preparing a predetermined concentration of buffer solution and resuspension of cell in the buffer solution in step 406. In step 408, the method further include the step of injecting the resuspended cell solution in the microfluidic channel 110 of the biosensor 100.

Further, in step 410, the method further comprises, applying differential potential and evaluating variation in electrical resistance from a plurality of electrodes in the biosensor 100 to analyze and obtain electrical and mechanical properties of the biological cell. In some embodiments, the predetermined concentration of buffer solution comprises 5% sucrose and 0.8% dextrose. In various embodiments, the differential potential is applied by using a function generator 202, and the variation in the electrical resistance is evaluated by using an impedance meter 204.

The advantages of the present invention include a) ability to check multiple cells simultaneously, b) ability to check the cell either in the form of adherent or suspension, c) biosensor device/equipment has high reliability and repeatability, d) incorporated as lab on chip device, e) Consumes less time for analysis and testing, f) less expensive than existing arts, g) occupies less space, and does not require hefty equipment.

The invention is further explained in the following examples, which however, are not to be construed to limit the scope of the invention.

### EXAMPLES

### Example 1: Definition

The examples in this section are presented for better understanding of manner of performance of a Dielectrophoresis-based biosensor, or Dielectrophoresis-based Mechanical Electrical Cell Sensor (DiMECS), and to explain the general rules of the system operation. Hence, these examples do not limit the functionality of the system and DiMECS can also be used in other cases. Also, the presented manufacturing process of DiMECS is not limited to the prototype presented herein, and those of skill in the art can use another, or any other method.

In the expressions given in the Examples section, the phrase “Resistance Deflection (RD)” is used several times. This word refers to the sudden drop of electrical resistance due to the connection between the sensor and ground electrodes by the elongated biological cells. One of the most important factor in our analyses is the distance between the ground and sensor electrodes; we named it as “Interstice between Ground and Sensor (IBGS)”. In all analyzes, there are three-major subjects illustrated with the numbers I, II and III. In the first case (I), the numbers and types of RDs are investigated. RDs indicate the ability of the cells to reach the desired elongation. In this section, the elastic property of the cells is analyzed.

In the second case (II), the time response of the cells and the pattern of electrical resistance variation are analyzed chronologically. In this section, the viscoelastic property of the cells is analyzed. In the third case (III), the quantity of electrical resistance variation in different parts of the graph (in. RDs, over time and at the—end of a test) is investigated. In this section, the electrical property of the cells is analyzed.

In the provided examples, various combination of cells is examined and the response of DiMECS is depicted. The ratio of the cells is shown as a: b. “a” is the volume ratio of the first cell type, and “b” is the volume ratio of the second cell type. The type of cells has been identified throughout the examples description.

### Example 2: Fabrication of Dielectrophoresis-Based Mechanical Electrical Cell Sensor (DiMECS)

In this example, the process of constructing Dielectrophoresis-based based biosensor, or Dielectrophoresis-based Mechanical Electrical Cell Sensor (DiMECS) is described. In the manufacturing process, first, the surface of substrate glass with 1 cm thickness was washed with acetone and IPA, then the surface was dehydrated. Following, a titanium layer with approximately 100 nanometers thickness was deposited on the surface of substrate using one of the common Physical Vapor Deposition (PVD) methods, such as Thermal Evaporation. Thereafter, 150 nm Au layer was deposited on the surface of deposited Ti layer using one of the common PVD methods, for example DC Sputtering.

Next, the pattern of the electrodes is made with the method of photolithography. In the layout, three electrodes: sensors, ground and source were created. Then, a dilute a layer of SU-8 (using cyclopentanone) was coated on the surface of electrodes using Spin Coat. It should be mentioned that SU-8 was chosen and predicted to be bio-compatible and suitable for patterning due to its inherent property of being a negative photoresist.

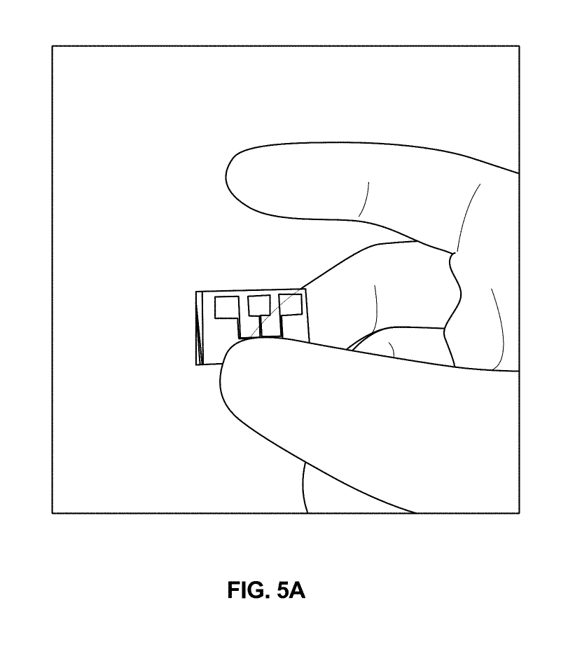

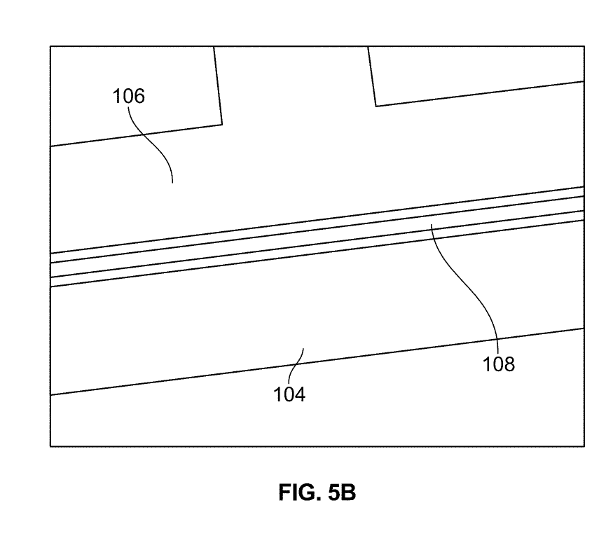

FIG. 5A and FIG. 5B show perspective views of the DiMECS held by fingers of a user, and a microscopic image of the layers in the fabricated DiMECS. The position of the electrodes and their pads are depicted. Further, the three electrodes, Sensor 104, Ground 106 and Source 108 electrodes were shown.

Finally, a PDMS microfluidic channel was fabricated using soft-lithography method. To this end, the SU-8 2050 (Microchem) was spin-coated on the surface of silicon wafer, soft-backed, exposed for 10 s, post-exposure-backed, developed in Propylene glycol methyl ether acetate (PGMEA) and hard-baked. Then PDMS mixed with a ratio of 10:1 of base with-cure agent, degassed, casting PDMS on the prepared patterned Su-8 mold and cured for at least 30 minutes on a hot plate. At the end, the prepared microfluidic channel was bonded into the prepared substrate with plasma bonding method.

### Example 3: DiMECS Bio-Compatibility Assessment

Two different tests were performed in order to ensure the reliability of the method of dielectrophoresis. In the first test, the cells were stained using the Trypan Blue ((3Z,3′ Z)-3,3′-[(3,3′-dimethylbiphenyl-4,4′-diyl) di (1Z) hydrazin-2-yl-1-ylidene] bis (5-amino-4-oxo-3,4-2 7-disutfonic acid, dihydronaphthalene)). Trypan Blue was used to analyse the viability of cells during a test in DiMECS. Trypan Blue can penetrate into the dead cells and stain their subcellular elements. Therefore, the effect of DiMECS on viability of cells can be evaluated.

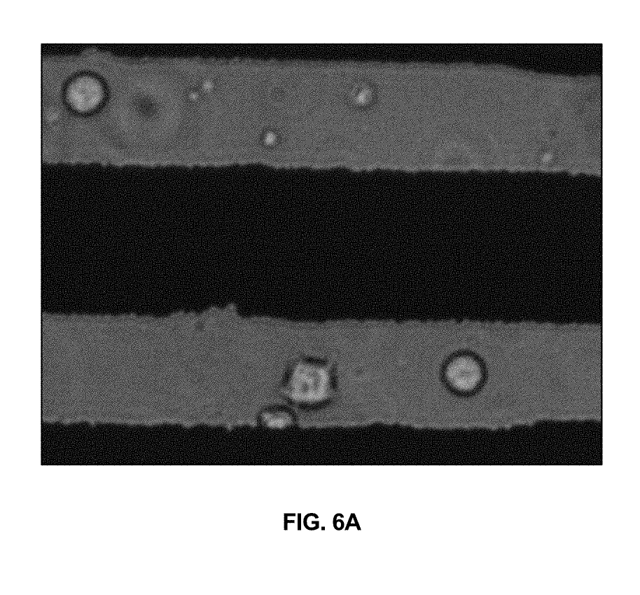

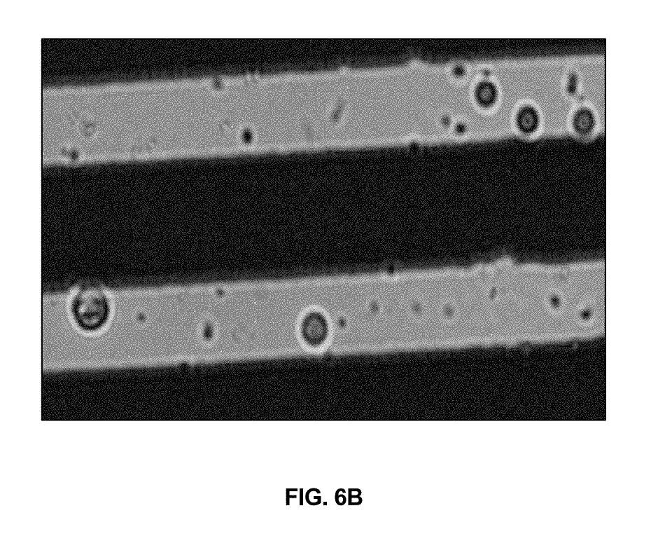

The tests were done in different voltages. FIG. 6A depicts the test in voltage of 8V. In this test, lymphocytes were stained with Trypan Blue (0.4%) and examined. In this voltage, the cells remained mostly uncolored and results indicate that only less than 20% of the cells are affected; therefore, the applied voltage is not hazardous significantly. The DEP buffer is not a suitable medium for maintenance of cells, and this is another reason of decline in viability of cells. FIG. 6B depicts the test in voltage of 12V. The applied voltage has decreased the viability of cells considerably. As shown in FIG. 6B, almost 80% of cells are dead. Therefore, the applied voltage is unsafe for viability of cells and would disturb the results of the test. Therefore, it can be concluded that if the applied voltage is below 8V, more than 80% of the cells remain healthy and ensure the accuracy of laboratory results.

In the second test, the tests were carried out throughout the cycles to ensure the results obtained within this biosensor were not altered due to damage to the cells during the tests. During this test, the stretching of cells was captured using a camera, then image processing was done with the Tracker software. First, the voltage of 8V was applied and about 40 seconds takes to reach its maximum stretch. Then, the applied voltage difference was reset to zero and let the cell to be relaxed. As shown, roughly the cell is returned to its original shape. After repeating this cycle for four times, almost no significant change was observed in the quantity of displacement. However, keeping the cells in the DEP buffer reduces the viability of cells and gradually reduces the accuracy of results.

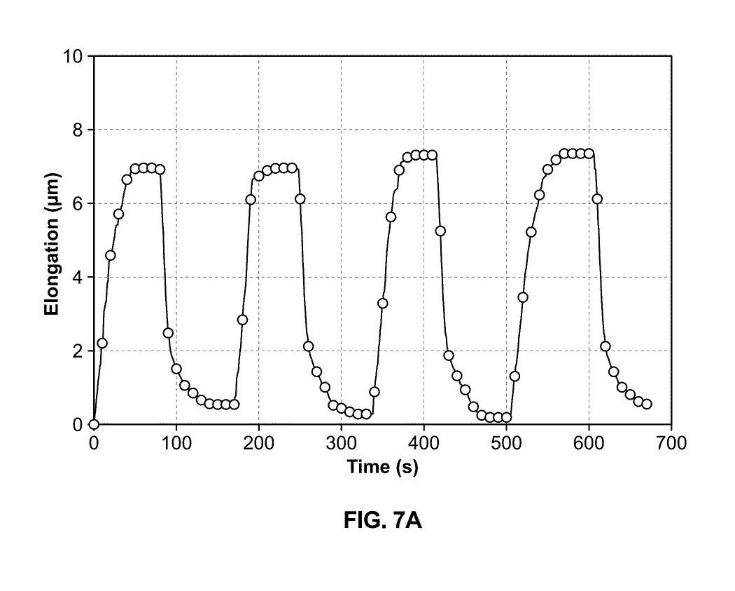

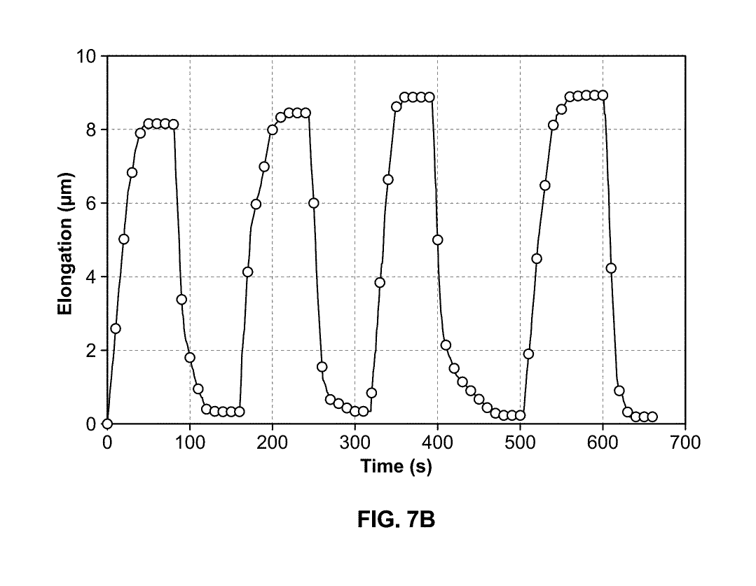

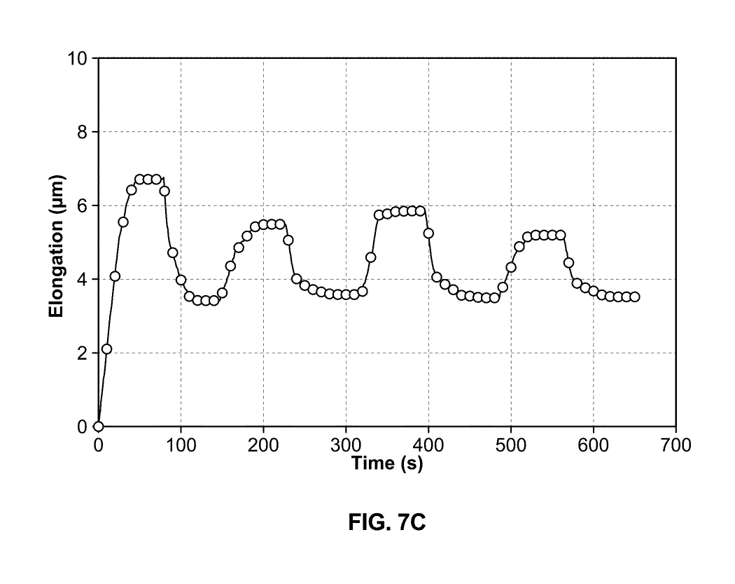

FIG. 7A shows time history of elongation of cells when potential difference is 8V, noticeable deviations were not seen over time. In FIG. 7B, the test was done for the applied voltage of 12V. No significant change was observed in the four cycles. Again, the test was performed in the maximum voltage of 16V as shown in FIG. 7C. In this test, there was a drop in the maximum displacement in the second and third cycles and the cells cannot find their original shape too. In many case, the lysis of cells was observed too. It can be inferred that the applied voltage (16 V) has a serious effect on the viability of the cells and the obtained results are invalid.

It can be inferred from the two aforesaid tests, the DEP method does not endanger the cells up to 8V. And the experimental results are sufficiently accurate. At the voltage of 12V, although the cells get disturbed and lose their viability, the mechanical response of the cells does not undergo serious changes, and the results obtained from the tests are admissible. But at higher voltages (16V), cells are severely dented and experimental results cannot be acceptable.

### Example 4: Study of Different Stages of Cancer Cells Using DiMECS

In this example, various stages of breast cancer cell lines (MCF-7 and MBA-MD-23) were studied using DiMECS. First, MCF-7 (endothelial Breast Cancer Cell Line) and MDA-MB-23 (Mesenchymal Breast Cancer Cell Line) cell lines were studied. The cell line preserved inside an incubator (37° C., 5% CO₂, 95% clear air) in DMEM and EMEM culture media (with 5% fetal bovine serum (FBS) and 1% penicillin), respectively. As the confluence reaches (80% confluency), after trypsinization of cells and detachment them from culture substrate, they were washed twice with PBS and the pellet cells were resuspended in DEP buffer. Immediately, the cells were inserted into the DiMECS and a low voltage is applied and the cells were allowed to absorb the edge of electrodes. Afterwards, the applied voltage is increased and the variation of electrical resistance between the ground and sensor electrodes were recorded. In the further analyses, MCF-7- and MDA-MB-231 cells were numbered as the first type and the second type, respectively.

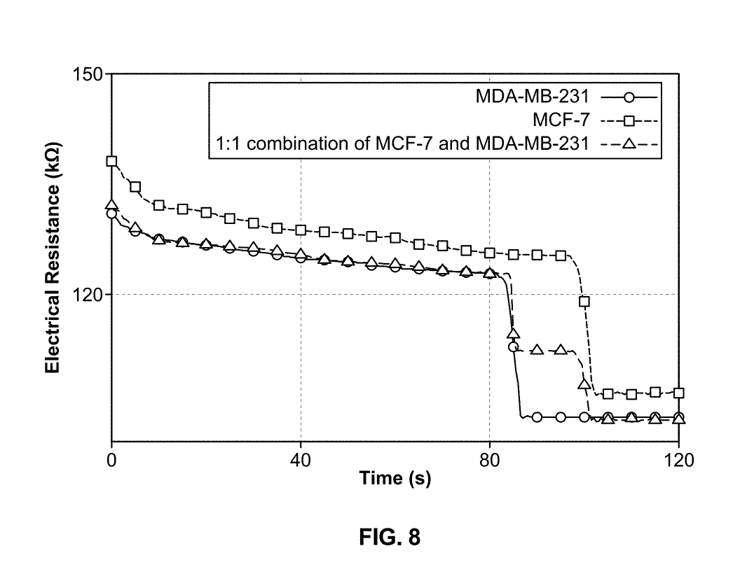

FIG. 8 shows time history of electrical resistance between the sensor and the ground electrodes of gap 18 μm. In these tests, three combinations of MDA-MB-231- and MCF-7 cells (1:0, 1:1) were used. In order to provide the opportunity of comparison between the results, all three graphs are represented in one graph. First, each cell type (MCF-7 or MDA-MB-231) was examined in DiMECS separately. Then, the 1:1 combination of these types of cells was examined too and synchronous effect of these cells on electrical resistance was analyzed. (I) There is one RD in the time response of single-cell-type samples (SCTS) (1:0 and 0:1) that attests to 18 micro meter elongation in both of the aforesaid cell lines. (II) The main distinguishable factor between MCF-7 and MDA-MB-231 was their viscoelastic property. The RD in MCF-7 SCTS analysis occurred at 100 s. It states that MCF-7 cell line takes 100 s to reach the 18 pm elongation. However, the RD in MDA-MB-231 SCTS analysis occurred at 83-84 s.

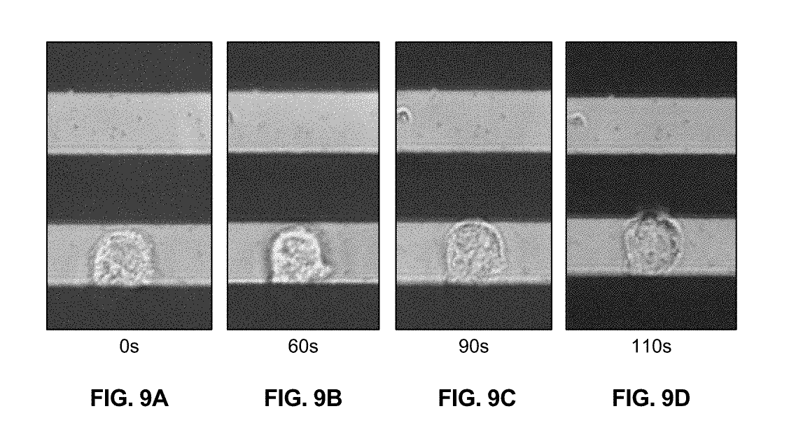

FIG. 9A-FIG. 9D illustrate microscopic images of a sample combination of MCF-7 and MDA-MB-231 in dielectrophoresis based biosensor, while the gap between sensor and ground electrodes was 18 μm in time 0 s, 60 s, 90 s and 110 s respectively. It can be inferred that the breast-cancer-mesenchymal-cells have a lower viscosity than endothelial ones. Therefore, this factor can be used to distinguish between MDA-MB-231 and MCF-7 cells.

In FIG. 8; the time response of 1:1 combination of these cell lines was depicted. There are two RDs in the diagram. The first one occurred at 84 s, caused by half of the cells that are MDA-MB-231. And the second one occurred at 100 s, caused by another half of the cells that are MCF-7 (III). Variations of electrical resistance in both of the cell type were the same. The smooth electrical resistance reduction before the RDs was approximately same and at the end of time history, the final electrical resistance had the same values and about 30-35 k OHM reduction in whole of time history was observed.

To testify the analysis about the experimental results, the elongation of the cells was captured with camera under an invert microscope for four different times. In these pictures, the sample is 1:1 combination of MDA-MB-231 and MCF-7 cells and the IBGS was approximately 18 micro meter. At this time, the cells were attached to the edge of electrodes by applying a low voltage (2V). At this voltage, noticeable elongation was not observed.

After 50 s, the applied voltage (10V) was increased. At this time, an elongation was observed in both of the cells, although none of them experiences RD. After 90 s, the applied voltage (10 V) was increased. At this time, the MDA-MB-231 cells were elongated up to 18 micro meter (as stated in our analysis, the MDA-MB231 cells bridge between the ground and sensor electrodes in about 84 s). However, MCF-7 cells have not still reached their highest level of elongation in this picture. After 110 s, the applied voltage (10 V) was increased, while both of the cell lines were elongated up to 18 micro meter (as stated in our analysis, the—MCF-7 cells bridge between the ground and sensor electrodes too in about 100 s).

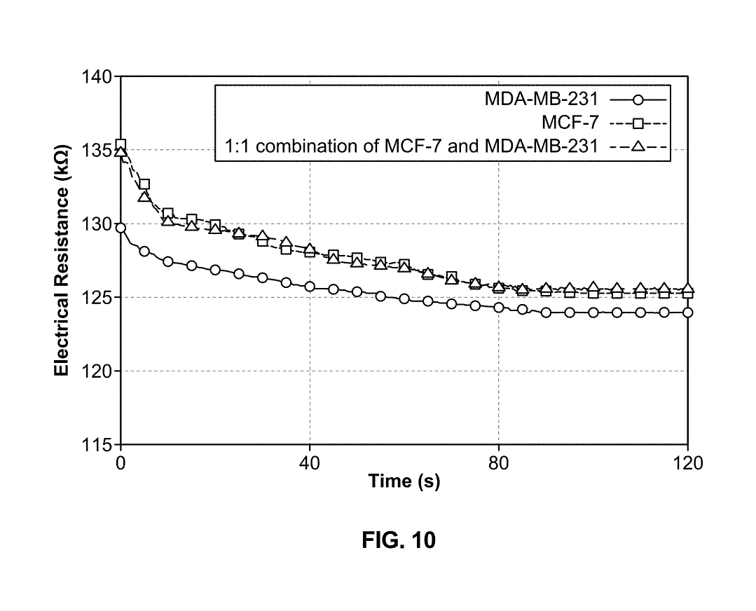

In FIG. 10, the time response of cells in DiMECS is depicted as IBGS was 20 micrometers. In these tests, three combinations of MDA-MB-231 and MCF-7 cells (1:0, 1:1, 0:1) were used. (I) in all of the examined tests, RD was not observed. The absence of RD indicates that none of the two cells-type (MDA-MB-231, MCF-7) is capable of elongation up to 20 micrometers. By comparison between the results presented in FIG. 8 and FIG. 10, it can be inferred that both of the cell types have the deformation capability up to 18 pm, but none of them can elongate up to 20 micro meter. Therefore, the elastic properties of these two cell-types are similar. (II) The time response of these two cell-types was roughly similar and remarkable difference was not observed throughout the time. (III) There was a slight drop in electrical resistance between the sensor and ground electrode. This is maybe due to the approaching of cells into the sensor electrode.

The results show-that electrical and elastic properties are not the distinguishing factors between MCF-7 and MDA-MB-231 cell lines. However, there is a clear distinction between the time response of these cells, and MDA-MB-231 cells shows RD sooner than MCF-7 cells, i.e. MCF-7 cells are more viscous than MDA-MB-231. As a result, DiMECS can be used to distinguish between different stages of breast cancer cell lines.

### Example 4: Assessment of Efficacy of Anti-Tubule Drugs on the Mechanical Properties of Cancer Cells Using DiMECS

In DiMECS, it was possible to evaluate the effect of anti-tubulin drugs on cytoskeletal of cells. In this example, we used DiMECS to evaluate the effect of one type of the anti-tubulin drugs on one of the breast cancer cell lines (MCF-7). First,-MCF-7 (Human-Breast Adenocarcinoma) was received a Biological Resource Center, and then the cells were preserved inside an Incubator (37° C., 5% CO2, 95% clean air) in EMEM culture media (with 5% Fetal Bovine Serum (FBS) and 1% penicillin). As the confluence reaches (80% confluency), 3 nano-mols/lit concentration of ABZ Drug were added to the cell culture flask. Then, it is preserved inside the incubator for 4 hours. Then the cells (both Treated MCF-7-(T-MCF-7) and MCF-7s that are untreated) were washed twice with PBS. At each stage, the cells were centrifuged in 125 g for 5 minutes and the surplus media was removed.

Finally, the MCF-7 pellet was resuspended inside the DEP buffer. T-MCF-7 and MCF4 cells were named as the first type and second type, respectively. Tests were performed for samples with different combinations (2:1, 1:1 and 1:2) as well as the SCTS (1:0 and 0:1). Then, the samples were inserted into the DIMECS fabricated according to the methods presented in this invention. Finally, the tests were performed and the variation of electrical resistance was stored.

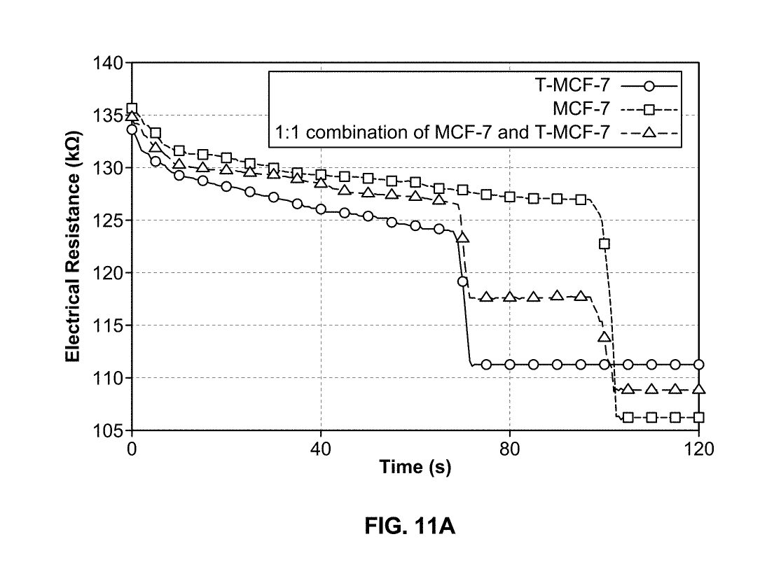

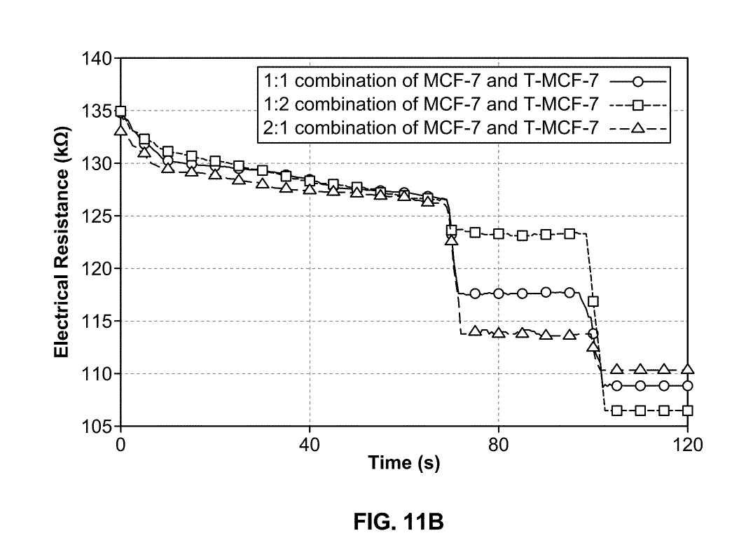

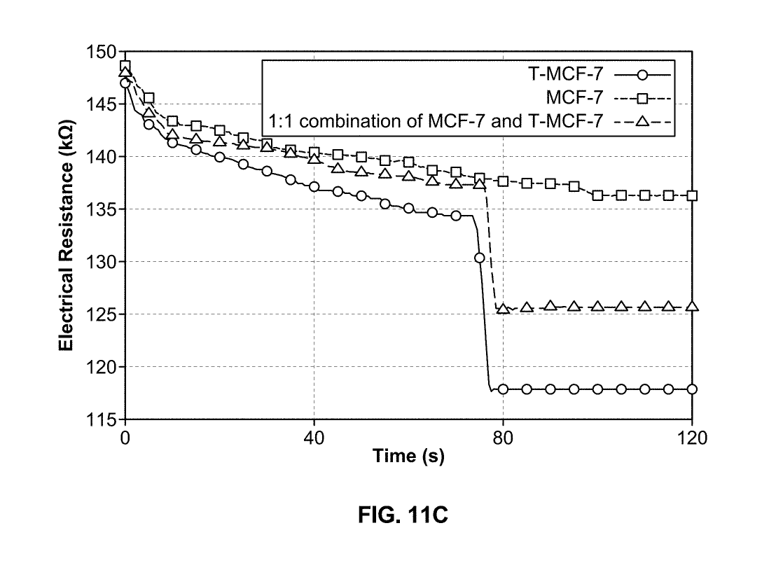

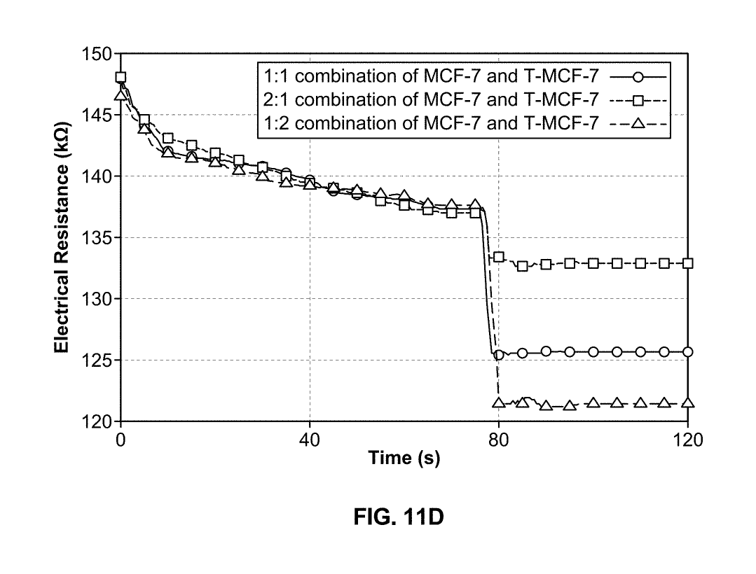

In FIGS. 11A-11D, the time history of electrical resistance variation is depicted. In FIGS. 11A and 11B, the IBGS is 18 micro meter and in FIGS. 11C and 11D, the 1 BGS is 20 micrometer. In these figures, the elastic, viscoelastic and electrical properties of cells have been analyzed.

In FIG. 11A, the IBGS is 18 micro meter. In this figure, three graphs are presented which two of them are related to SCTS of MCF-7 and T-MCF-7 cells. The graphs are presented to clarify the DiMECS responses for samples with combination of these types of cells. (I) in both of the graphs presented for SCTS, one RD is observed. It can be inferred that both of cell-types (MCF-7 and T-MCF-7) have deformation capability up to 18 micro meter (II) The RD in MCF-7 SCTS analysis occurs at 100 s. It states that MCF-7 cell line takes 100 s to reach the 18 micro meter elongation. However, the RD in T-MCF-7 SCTS analysis occurs at 70s approximately.

It can be inferred that the Anti-tubulin drugs reduces the viscosity of cancerous cells. (Ill) In MCF-7 SCTS, about 40 kilo ohm reduction in electrical resistance between the Ground and Sensor electrodes has been seen throughout the time. The reduction involves a gradual decrease over time before RD (It is maybe due to the approaching of cells into the Sensor electrode) and a sudden drop in the RD. In MCF-7 SCTS, the reduction is about 33-35 Kilo ohm which is less than MCF-7 SCTS. The origin of this reduction is in resistance reduction in the RD.

In FIG. 11A, the time history of electrical resistance variation for a sample of 1:1 combination of T-MCF-7 and MCF-7 cells is depicted. (I) In this graph two RDs can be seen. By comparing this diagram with the results of SCTS, it is interpreted that first RD is related to T-MCF-7 and the second one is related to the MCF-7. Generally, it can be inferred from the graph that there are two types of cells that have deformation capability up to 18 micro meter. (II) Viscoelastic properties of the cell can be measured by analyzing the electrical resistance throughout the time.

After 70 seconds, the first RD was seen. This RD, which is related to the first cells, indicates that the first cell (here T-MCF-7) takes 70 s to elongate up to 18 pm. The resistance was almost constant between 74-100 seconds. There was another RD in 100 s. This RD indicates that a second cell (in this case MCF-7) has been injected-inside DIMECS which needs 100 seconds to reach the 18 micro meter elongation. (III) The critical juncture in this case is the rate of electrical resistance variation. In sample of 1:1 combination of T-MCF-7 and MCF-7 cells, before the first RD—the electrical resistance is between the SCTS results. The resistance reduction in the first-RD was less than T-MCF-7 SCTS. This maybe because of reduction in the number of T-MCF-7 cells, i.e. the number of T-MCF-7 in this sample was half of the T-MCF-7 SCTS. No significant variation was observed between seconds 75 and 100.

In second RD caused-by-the connection of the-second cells (in this case MCF-7) from ground to source, again the resistance reduction is less than MCF-7 SCTS. Although, the resistance reduction in each RD was less than the relevant SCTS, the ultimate electrical resistance reduction at the end of the test which is the sum of smooth reduction-before the first RD, the first RD and the second RD, greater than the T-MCF-7 SCTS and less than MCF-7 SCTS.

In FIG. 11B, the time history of electrical resistance variation is depicted for samples &three (1:2, 0.1:1 and 2:1) combination of T-MCF-7 and MCF-7 cells when IGBS is 18 micro meter. For making comparison between the presented results, all the results were displayed in a single Figure. (I) in all of these samples, there are two RDs; consequently, there are two types of cells that have a deformation capability up to’ micro meter. (II) in all of these samples, RDs occurs at 74 s and 100s which are related to T-MCF-7 and MCF-7, respectively (111). The distinguishable factor for different samples with different concentration was their electrical resistance variations. The more the ratio of MCF-7 cells in compare of T-MCF-7 cells was, the less the ultimate electrical resistance was found to be.

The time history can be divided into four parts: (1) from the beginning of the analysis to the first RD (2) first RD (3) from first RD to second RD (4) second RD. In the first part, by changing the cell's ratio, variation of time history of electrical resistance was negligible. In the second-part, by increasing the ratio of MCF-7 to T-MCF-7 (the less effective pharmacotherapy), resistance reduction in the first RD was decreased. In the third step, regarding the small drop-of resistance, there was not any visible changes in the electrical resistance. In—the fourth step, by increasing the ratio of MCF-7 to T-MCF-7, resistance reduction of the second RD increased. In conclusion, by analyzing the reduction in RDs, it is possible to evaluate the efficiency of pharmacotherapy.

To determine the effect of anti-tubulin drugs on the maximum elongation, the response of DiMECS has been evaluated for different combination (0:1, 1:2, 1:1, 2:1, 1:0) of cells when IBGS was 20 micrometer. In FIG. 11C, the time history of electrical resistance variation for SCTS and 1:1 combination of T-MCF-7 and MCF-T cells is depicted. In FIG. 11D, the time history of electrical resistance variation was depicted for three samples with different combinations (1:2, 1:1, 2:1) of MCF-7 and T-MCF, 7 was depicted when IBGS ‘is 20 micrometer.

In FIG. 11C, the experiments are performed using DiMECS when IBGS was 20 micrometer. FIG. 11C contains three graphs. One of the graphs is related to MCF-7 SCTS analysis. In this graph, electrical resistance reduces gently; however, in the time history, no RD was observed. Absence of RD indicates that the desired cells (MCF-7) do not have the deformation ability up to 20 micro meter. The gentle electrical resistance reduction throughout the time may be due to the approaching of cells into the sensor electrode.

Another graph in FIG. 11C is related to T-MCF-7 SCTS analysis. In this graph, after a gentle electrical resistance, a RD was seen in 78 s. This RD represents the arrival of cells from the ground to source electrode; thus the T-MCF-7 cells, unlike the MCF77-cells have the-deformation ability up to 20 micro meter. In FIG. 11C, 1:1 combination of MCF-7 and T-MCF7 were also been analyzed. (1) only one RD was seen. Regarding the results of MCF-7 SCTS and T-MCF-7 SCTS: analyses, it can be inferred that this RD is related to T-MCF-7 cells. MCF-7 cells do not provide any RD in the presented graph (ii) at the beginning of the test, the electrical resistance reduces upto 82 s. Then, a RD results from the arrival of the T-MCF-7 cells into sensor electrode in 82 s.

By comparing, the results in FIG. 11C with presented results in FIG. 11A, it is inferred that TMCF-7 cells require about 8 seconds to elongate the 2 micro meter between 18 micro meter and 20 micrometer. After the RD, no significant changes were observed: (iii) at the beginning, the electrical resistance is reduced gently. The reason of this reduction may be due to the approaching of both the cells (T-MCF4 and MCF=7) into the Sensor electrode. There is a RD in the graph, which-depends on the electrical properties and the number of T-MCF-7. The number of MCF-7 cells does not have any effect-on this RD. Therefore, due to the fact that the number of TMCF-7 cells decreased in this experiment compared to the T-MCF-7 IBGS analysis, the electrical resistance reduction was also decreased (dropped from 18 to 10.5 approximately). After this RD, the electrical resistance variation is not noticeable.

In FIG. 11D, the time history of electrical resistance variation was depicted for samples of three (1:2, 1:1 and 2:1) combination of T-MCF-7 and MCF-7 cells when IGBS is 20 micrometer (I) in all of these analyses, only one RD was seen which indicates the 20 micrometer elongation-of T-MCF-7 cells and inability of MCF-7 to elongate up to 20 micrometer. (II) the time history of electrical resistance variation of these samples was in a same manner and there was a RD in 78 s. (III) more the ratio of MCF-7 to T-MCF-7, the less the electrical resistance variation will be in the RD: Regarding the fact that a RD shows the connection between the sensor and ground electrodes by the elongated biological cells, reducing the number of these cells decreases the effect-of this RD. Consequently, regarding the fact that major reduction in ultimate electrical resistance is due the electrical resistance reduction in the RD, the ultimate electrical resistance reduction decreased by increasing the ratio of MCF-7 to T-MCF-7.

The foregoing description comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions.

Although specific terms may be employed herein, they are used only in generic and descriptive sense and not for purposes of limitation. Accordingly, the present invention is not limited to the specific embodiments illustrated herein. While the above is a complete description of the preferred embodiments of the invention, various alternatives, modifications, and equivalents may be used. Therefore, the above description and the examples should not be taken as limiting the scope of the invention, which is defined by the appended claims.

1. A dielectrophoresis based biosensor, comprising:
a substrate having a surface;
a source electrode, a ground electrode and a sensor electrode being positionable on the surface of said substrate where a dielectrophoretic force is exerted by said electrodes, wherein the source electrode and the ground electrode are separated by a predetermined distance, and the sensor electrode is positioned between the source electrode and the ground electrode, and
a microfluidic channel positioned on the substrate to place the biological cell at a desired position to evaluate the mechanical and electrical properties of a biological cell.

2. The biosensor of claim 1, further comprising a function generator configured to apply differential potential between the source electrode and the ground electrode to create an electric field in the sensor electrode.

3. The biosensor of claim 1, further comprising an impedance meter to measure electrical resistance variation between the ground and the sensor electrodes.

4. The biosensor of claim 1, wherein the desired position of placing the biological cell is between the source electrode and ground electrode.

5. The biosensor of claim 1, wherein the sensor electrode has high permittivity and acts as an electric field barrier.

6. The biosensor of claim 1, wherein the electrodes comprise one or more pads to connect the function generator and the impedance meter.

7. A method of fabricating dielectrophoresis based biosensor, comprising the steps of:
providing a substrate with a surface;
coating a layer of titanium (Ti) or chromium (Cr) on the surface of the substrate;
coating a layer of gold (Au) on the surface of the coated titanium (Ti) or chromium (Cr) layer of the substrate;
patterning the coated surface of the substrate to form three electrodes;
coating a passivation layer on the surface of said electrodes, and
positioning a microfluidic channel to receive a dielectrophoresis buffer with biological cells on the substrate.

8. The method of claim 7, wherein the substrate is one of silicon wafer or glass.

9. The method of claim 7, wherein the layer of titanium (Ti) or chromium (Cr) is coated on the substrate to intensify the bonding strength between the substrate and gold (Au) layer.

10. The method of claim 7, wherein the thickness of the titanium (Ti) or chromium (Cr) layer, and gold layer is about 160 nms.

11. The method of claim 7, wherein the passivation layer is coated on the surface of said electrodes using a diluted SU-8.

12. The method of claim 7, wherein the passivation layer is configured to prevent direct contact of the dielectrophoresis buffer with the electrodes.

13. The method of claim 7, wherein the thickness of the passivation layer is about 1 micron.

14. The method of claim 7, wherein the microfluidic channel is polydimethylsiloxane (PDMS)-based microfluidic channel.

15. The method of claim 7, wherein the microfluidic channel is positioned on the substrate using plasma bonding method.

16. The method of claim 7, wherein the step of patterning the coated surface of the substrate to form three electrodes is done by photolithographic process.

17. The method of claim 7, wherein the electrodes include a source electrode, a ground electrode and a sensor electrode.

18. A method of performing test by using dielectrophoresis based biosensor, comprising the steps of:
isolating or culturing of biological cells;
washing and centrifuging the isolated cells;
preparing a predetermined concentration of buffer solution and resuspension of cell in the buffer solution;
injecting the resuspended cell solution in the microfluidic channel of the biosensor, and
applying differential potential and evaluating variation in electrical resistance from a plurality of electrodes in the biosensor to analyze and obtain electrical and mechanical properties of the biological cell.

19. The method of claim 18, wherein the predetermined concentration of buffer solution comprises 5% sucrose and 0.8% dextrose.

20. The method of claim 18, wherein the differential potential is applied by using a function generator, and the variation in the electrical resistance is evaluated by using an impedance meter.
